(19) United States
(12) Patent Application Publication
(10) Pub. No.: US 2014/0321156 A1
(43) Pub. Date: Oct. 30, 2014

(54) BACKLIGHT DEVICE

(71) Applicant: Sharp Kabushiki Kaisha, Osaka (JP)

(72) Inventor: Takahiro Yoshikawa, Osaka (JP)

(73) Assignee: SHARP KABUSHIKI KAISHA, Osaka (JP)

(21) Appl. No.: 14/356,460

(22) PCT Filed: Nov. 5, 2012
(86) PCT No.: PCT/JP2012/078566

§ 371 Date: May 6, 2014

(30) Foreign Application Priority Data
Nov. 11, 2011 (JP) 2011-247532

(51) Int. Cl. F21V 8/00

(52) U.S. Cl. CPC G02B 6/0033
USPC 362/607

(57) ABSTRACT

A backlight device (10) includes a chassis (11), reflective sheets (16L and 16R) on the surface of the chassis, and an edge-lit light guide plate (13) on the reflective sheets. The two reflective sheets cover the chassis. Adjacent edges of the reflective sheets overlap each other, and a housing portion (17) to house the overlapping portion of these adjacent edges is formed in the chassis.

### TECHNICAL FIELD

The present invention relates to a backlight device that attaches to a display panel.

### BACKGROUND ART

A backlight device usually attaches to a display panel such as a liquid crystal panel, for example, which does not emit light on its own. An example of a backlight device that attaches to a liquid crystal panel is disclosed in Patent Document 1.

The backlight device disclosed in Patent Document 1 has a light-emitting unit attached to a heat dissipating plate and this light-emitting unit has a large number of light-emitting diodes (LEDs) mounted on a wiring substrate. A plurality of these light-emitting units are arranged in a row on the back surface of the liquid crystal panel, and the light emitted from the LEDs illuminates the liquid crystal panel through optical sheet blocks. In this backlight device, a large number of reflective sheets that attach to each light-emitting unit and the reflective plates fixed to the heat-dissipating plates form a reflective part that reflects light emitted from the LEDs.

### RELATED ART DOCUMENT

### Patent Document

Patent Document 1: Japanese Patent Application Laid-Open Publication No. 2006-49098

### SUMMARY OF THE INVENTION

### Problems to be Solved by the Invention

A backlight device that has LEDs arranged on the back of the liquid crystal panel, such as the backlight device disclosed in Patent Document 1, needs to have at least a certain thickness. So-called edge-lit backlight devices, in which light emitted from the LEDs is radiated on the edge faces of the light guide plate and the direction of the light is changed inside the light guide plate to illuminate the liquid crystal panel from behind, have recently become widely used as a thin backlight device.

FIG. 7 shows an example of an edge-lit backlight device. A backlight device 10 attached to a liquid crystal panel 1 has a tray-shaped chassis 11. The chassis 11 is rectangular in a plan view and formed by sheet metal stamping or injection molding with a synthetic resin. A liquid crystal panel stand 12 that supports the liquid crystal panel 1 is fixed in an opening in the chassis 11. A light guide plate 13 that is substantially rectangular in a plan view is arranged inside the chassis 11. It is common for the light guide plate 13 to have cut-outs on the edges thereof for positioning and the like, and for the outline of the light guide plate to have an irregular rectangular shape.

The light guide plate 13 receives light emitted from LEDs 14, which are light sources, from one edge face or a plurality of edge faces, and changes the direction of this light to travel towards the liquid crystal panel 1. The light exiting from the light guide plate 13 goes through an optical sheet unit 15 constituted of optical sheets such as a diffusion sheet, a microlens sheet, a prism sheet, and a polarizing reflective sheet, and illuminates the liquid crystal panel 1.

A reflective sheet 16 overlaps the surface of the chassis 11 such that as much light as possible that enters the light guide plate 13 will travel towards the liquid crystal panel 1. The light guide plate 13 overlaps this reflective sheet 16. A material with a high reflectance made of a polyethylene terephthalate (PET) foam or the like is used for the reflective sheet 16.

The edge-lit backlight device shown in FIG. 7 as an example has also recently begun to be used for large television receivers. It is not possible to manufacture a reflective sheet that is large enough to cover a large liquid crystal panel such as the 70″ model with one sheet; therefore, a plurality of sheets (usually two) are combined together to form the reflective sheet. Such a case causes the following problems.

Two reflective sheets are drawn in FIG. 8. The sheet on the left in the drawing is a reflective sheet 16L, and the sheet on the right in the drawing is a reflective sheet 16R. The reflective sheet 16L and reflective sheet 16R cover the entire chassis 11. The adjacent edges of the reflective sheets 16L and 16R perfectly overlap each other in the middle of the chassis 11. The overlapping section is thicker and closely adheres to the light guide plate 13. The light guide plate 13 becomes brighter at this section. There are spaces S respectively between the reflective sheet 16L and chassis 11 and between the reflective sheet 16R and light guide plate 13 where the reflective sheets 16L and 16R are not overlapping. The spaces S have a negative effect on the brightness of the light guide plate 13 and cause a slight drop in the brightness thereof. Accordingly, the uneven brightness of the light guide plate 13 can be seen by the viewer.

The present invention was made to improve on the above-mentioned points, and aims at preventing the attachment of the reflective sheets to a light guide plate from causing uneven brightness therein even if adjacent edges of two of the reflective sheets overlap.

A backlight device according to the present invention includes: a chassis; a reflective sheet covering a surface of the chassis; and a light guide plate covering the reflective sheet, wherein the reflective sheet is made of a plurality of reflective sheets, and wherein the chassis includes a housing portion that houses overlapping edges of mutually adjacent reflective sheets.

In the backlight device of the above-mentioned configuration, it is preferable that the reflective sheets of the edges of the reflective sheet be a direction normal to the surface of the chassis, and the housing portion house an edge of the edges closer to the chassis.

In the backlight device of the above-mentioned configuration, it is preferable that the edge of the reflective sheet housed in the housing portion be bent in a crank-like shape.

In the backlight device of the above-mentioned configuration, it is preferable that the overlapping portion of the edges of the reflective sheets be parallel with a surface of the chassis, and the housing portion house the edges that are overlapping.

In the backlight device of the above-mentioned configuration, it is preferable that the edges of the reflective sheets housed in the housing portion be bent in an “L”-shape.

In the backlight device of the above-mentioned configuration, it is preferable that the housing portion be made of a recess formed in the chassis.

In the backlight device of the above-mentioned configuration, it is preferable that the housing portion be made of a penetrating hole formed in the chassis.

In the backlight device of the above-mentioned configuration, it is preferable that the penetrating hole be covered by a lid from outside of the chassis.

In the backlight device of the above-mentioned configuration, it is preferable that a pair of the reflective sheets having the overlapping edges be symmetrical.

### Effects of the Invention

According to the present invention, the overlapping portion of the edges of the reflective sheet segments can be housed in the housing portion of the chassis, and thus, a configuration in which only a portion of the reflective sheet closely adheres to the light guide plate will be avoided. Therefore, it is possible to prevent uneven brightness of the light guide plate from occurring even with a large backlight device that requires a plurality of reflective sheets to be combined together.

### BRIEF DESCRIPTION OF THE DRAWINGS

FIG. 1 is a schematic cross-sectional view of a portion of a backlight device according to Embodiment 1.

FIG. 2 is a schematic cross-sectional view of a portion of a backlight device according to Embodiment 2.

FIG. 3 is a schematic cross-sectional view of a portion of a backlight device according to Embodiment 3.

FIG. 4 is a schematic cross-sectional view of a portion of a backlight device according to Embodiment 4.

FIG. 5 is a plan view of reflective sheets of a backlight device according to Embodiment 5.

FIG. 6 is a plan view of reflective sheets of a backlight device according to Embodiment 6.

FIG. 7 is a view for explaining a configuration of a backlight device.

FIG. 8 is a view for explaining problems with a conventional backlight device.

### DETAILED DESCRIPTION OF EMBODIMENTS

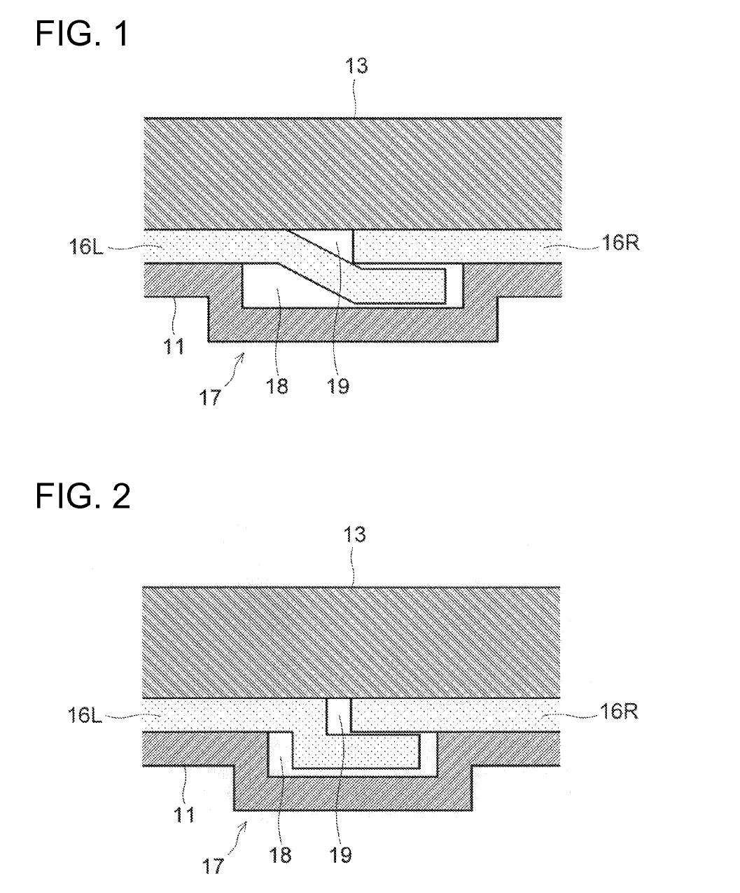

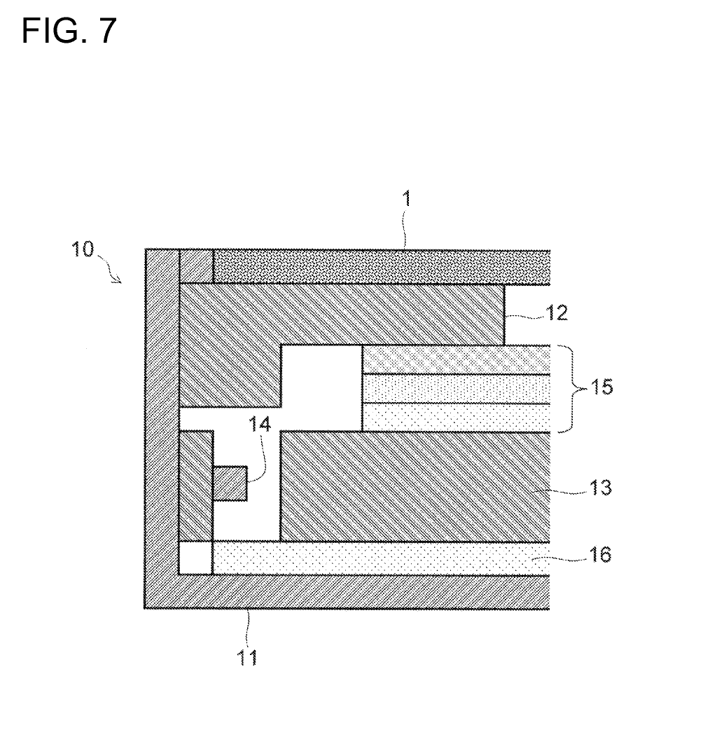

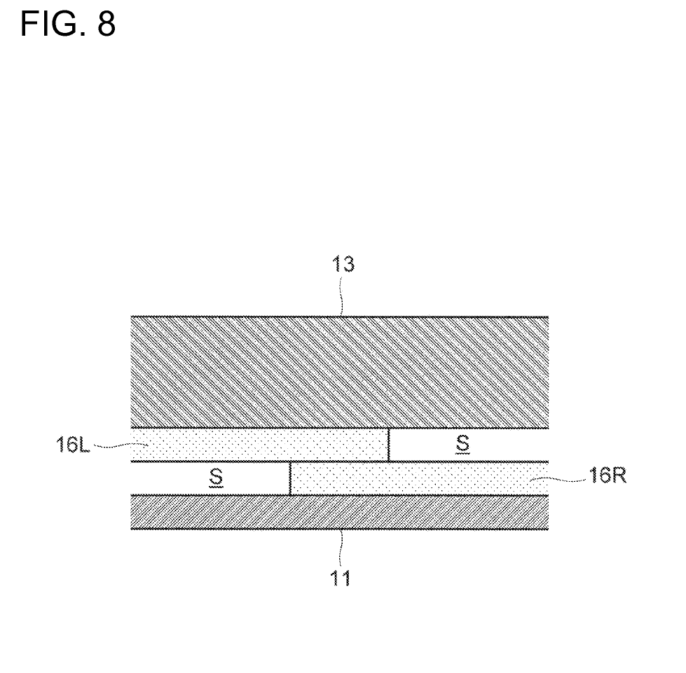

Embodiments 1 to 6 of a backlight device of the present invention will be explained below on the basis of FIGS. 1 to 6. In the respective embodiments, constituting elements that are functionally the same as those in the backlight device in FIGS. 7 and 8 will be assigned the same reference characters as in FIGS. 7 and 8 and an explanation thereof will be omitted.

FIG. 1 shows Embodiment 1. In a backlight device 10 of Embodiment 1, adjacent edges of a reflective sheet 16L and a reflective sheet 16R overlap in a direction normal to the surface of a chassis 11. The edge of the reflective sheet 16L towards the chassis 11, or namely, the bottom of the drawing. A housing portion 17 that houses the overlapping portion of the adjacent edges of the reflective sheets 16L and 16R is formed in the chassis 11.

The housing portion 17 of Embodiment 1 is constituted of a recess 18 formed in a trench shape going across the chassis 11. The recess 18 has a sufficient depth and width for receiving the edge of the reflective sheet 16L on the bottom. The recess 18 may have a larger width than the overlapping portion of the reflective sheet 16L and reflective sheet 16R. It is preferable that the depth of the recess 18 be greater than the thickness of a single reflective sheet.

In this manner, the overlapping portion of the adjacent edges of the reflective sheets 16L and 16R can be housed in the housing portion 17 of the chassis 11; therefore, a configuration in which only a portion of the reflective sheet closely adheres to the light guide plate is avoided. Therefore, it is possible to prevent uneven brightness of the light guide plate 13 from occurring even with a large backlight device 10 that requires a plurality of reflective sheets to be combined together.

FIG. 2 shows Embodiment 2. Embodiment 2 is different than Embodiment 1. Namely, in Embodiment 1, the edge of the reflective sheet 16L is housed in the housing portion 17 at a curve while being pressed by the edge of the reflective sheet 16R. In Embodiment 2, however, the edge of a reflective sheet 16L is bent into a crank-like shape in advance. There is a gap 19 between the corner of the bent part of the reflective sheet 16L and the edge face of the reflective sheet 16R, but this gap 19 can be made narrower than a similar gap 19 in Embodiment 1. Thus, the width of a recess 18 can be narrowed more than in Embodiment 1.

If one of the edges of the overlapping adjacent edges of the reflective sheets 16L and 16R is bent into a crank-shape in advance in this manner, then the gap around the overlapping portion of the adjacent edges can be made smaller and uneven brightness can be reduced further when overlapping a light guide plate 13.

The crank-like shape of the edge of the reflective sheet may be formed by injection molding or by bending. Alternatively, perforations may be formed in the reflective sheet in advance and then the bending may be performed at the assembly site. If the perforation method is used, then the reflective sheets can be stored flat until time of assembly and not take up much storage space.

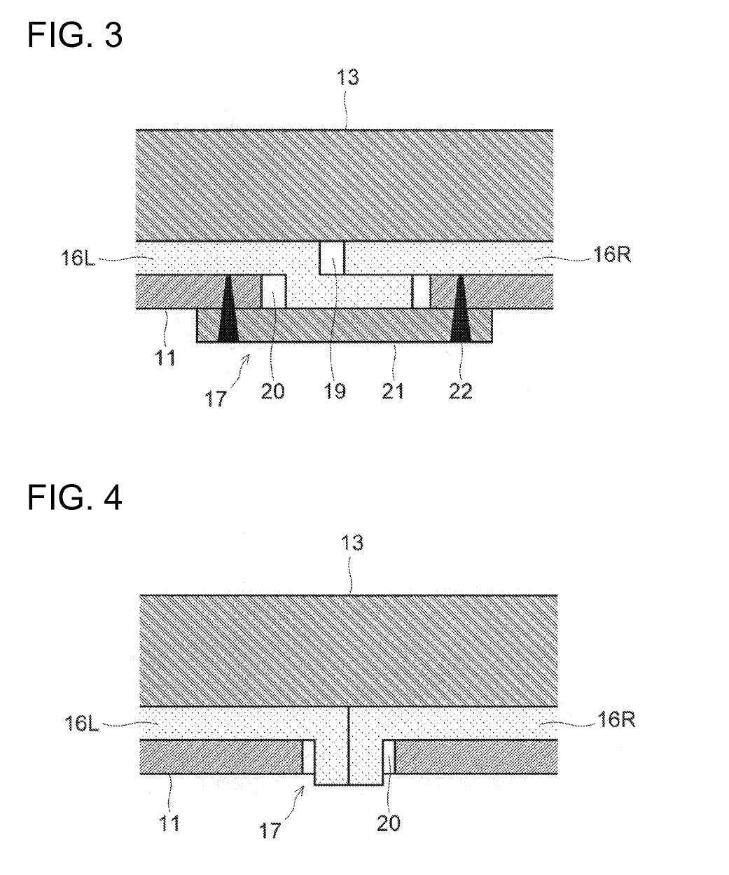

FIG. 3 shows Embodiment 3. Embodiment 3 is different than Embodiment 2. A penetrating hole 20 formed in a chassis 11 constitutes a housing portion 17. The penetrating hole 20 is a long hole that goes across the chassis 11. With this configuration, the housing portion 17 can formed by a punching process with ease.

The penetrating hole 20 is closed from the outside of the chassis 11 by a lid 21. This makes it possible to prevent foreign matter from entering the housing portion 17 from outside. The lid 21 is fixed to the chassis 11 by fixing structures 22 such as screws, and this compensates for the decrease in strength of the chassis 11 due to the formation of the penetrating hole 20.

FIG. 4 shows Embodiment 4. A housing portion 17 in Embodiment 4 is also formed by a penetrating hole 20. Overlapping adjacent edges of a reflective sheet 16L and reflective sheet 16R are respectively bent in an “L”-shape, and these bent portions abut each other. In other words, the overlapping portion of the reflective sheets 16L and 16R is in a direction that is parallel with the surface of the chassis 11.

The housing portion 17 houses both the edge of the reflective sheet 16L and the edge of the reflective sheet 16R. The respective portions of the reflective sheets 16L and 16R past the corner parts of the “L” shape are housed in the housing portion 17. The tip of the edges of the reflective sheets 16L and 16R protrude from the penetrating hole 20.

The gap 19 between the reflective sheets 16L and 16R in Embodiments 1, 2, and 3 can be almost eliminated in Embodiment 4. This further reduces uneven brightness.

The “L”-shaped bent shape of the reflective sheet 16L and 16R is simpler than the crank-like bent shape of the reflective sheet 16L in Embodiments 2 and 3, and thus, an improvement in the production accuracy thereof can be expected. If the reflective sheets 16L and 16R are fixed to the chassis 11 by double-sided tape or the like in the vicinity of the penetrating hole 20, then the reflective sheets 16L and 16R can be prevented from shifting in position due to vibrations or the like.

The “L”-shape of the edges of the reflective sheets may be formed by injection molding or by bending. Alternatively, perforations may be formed in the reflective sheet in advance and then the bending may be performed at the assembly site. If the perforation method is used, then the reflective sheets can be stored flat until time of assembly and not take up much storage space.

The penetrating hole 20 in Embodiment 4 can be sealed by a separate lid from outside to prevent foreign matter from entering the housing portion 17 from outside, in a manner similar to Embodiment 3. This can compensate for the decrease in strength of the chassis 11 due to the formation of the penetrating hole 20.

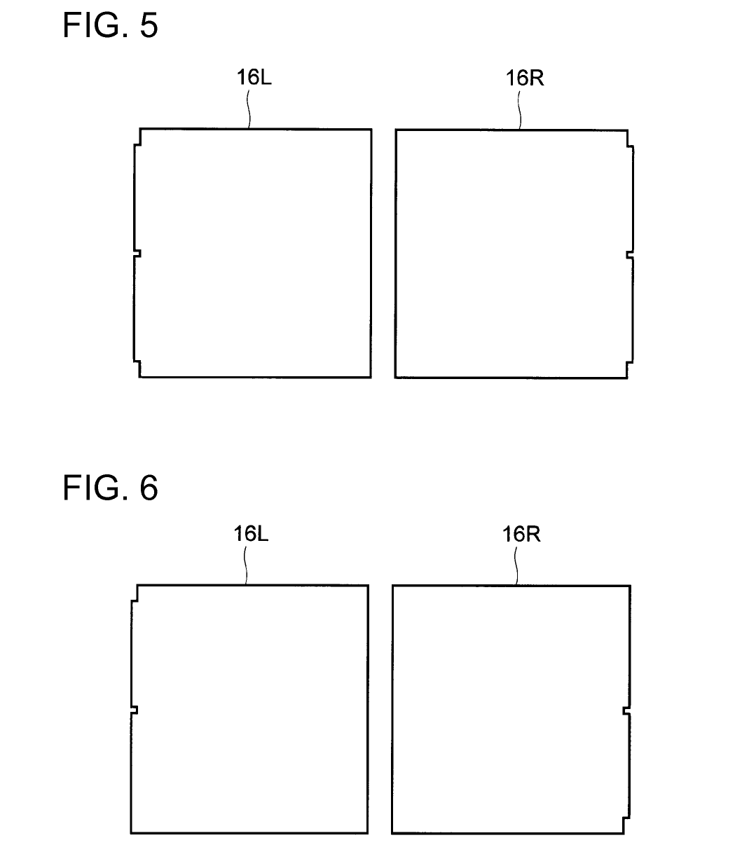

FIG. 5 shows Embodiment 5. In Embodiment 5, attention should be paid to the plan view of reflective sheets 16L and 16R. Namely, the reflective sheets 16L and 16R are bilaterally symmetrical, or in other words, have line symmetry. This makes it possible to prepare a reflective sheet of only one shape for the reflective sheet 16L and the reflective sheet 16R and allows for a reduction in molding.

FIG. 6 shows Embodiment 6. In Embodiment 6, reflective sheets 16L and 16R are point-symmetrical. This configuration also makes it possible to prepare a reflective sheet of only one shape, allowing a decrease in molds.

In the respective embodiments above, an explanation was provided based on there being two reflective sheets, but the present invention can be applied even if there are three or more reflective sheets.

Embodiments of the present invention were described above, but the scope of the present invention is not limited thereto, and can be implemented with various modifications without departing from the spirit thereof.

### INDUSTRIAL APPLICABILITY

The present invention is widely applicable to edge-lit backlight devices.

### DESCRIPTION OF REFERENCE CHARACTERS

1 liquid crystal panel
10 backlight device
11 chassis
13 light guide plate
14 LED
15 optical sheet unit
16L, 16R reflective sheet
17 housing portion
18 recess
20 penetrating hole
21 lid

1. A backlight device, comprising:
a chassis;
a reflective sheet covering a surface of the chassis; and
a light guide plate covering the reflective sheet,
wherein the reflective sheet is made of a plurality of reflective sheet segments that are laterally disposed and mutually adjacent, and
wherein the chassis includes a housing portion that houses at least one edge of mutually adjacent reflective sheet segments.

2. The backlight device according to claim 1,
wherein the mutually adjacent reflective sheet segments of the reflective sheet overlap each other in a direction normal to the surface of the chassis, and
wherein the housing portion houses an edge of one of the mutually adjacent reflective sheet segments closer to the chassis.

3. The backlight device according to claim 2,
wherein said edge of one of the mutually adjacent reflective sheet segments is bent in a shape that accommodates another reflective sheet segment.

4. The backlight device according to claim 1,
wherein the mutually adjacent reflective sheet segments are parallel with a surface of the chassis, and
wherein the housing portion houses edges of both mutually adjacent reflective sheet segments.

5. The backlight device according to claim 3,
wherein at least one of the edges of the reflective sheet segments housed in the housing portion is bent in an “L”-shape.

6. The backlight device according to claim 1,
wherein the housing portion is made of a recess formed in the chassis.

7. The backlight device according to claim 1,
wherein the housing portion is made of a penetrating hole formed in the chassis.

8. The backlight device according to claim 7,
wherein the penetrating hole is covered by a lid from outside of the chassis.

9. The backlight device according to claim 1,
wherein a pair of the reflective sheets having the overlapping edges is symmetrical.
